(19) United States
(12) Patent Application Publication
(10) Pub. No.: US 2026/0032058 A1
(43) Pub. Date: Jan. 29, 2026

(54) COMMUNICATION PROTOCOL FOR MACHINE LEARNING

(71) Applicant: Marvell Asia Pte Ltd, Singapore (SG)

(72) Inventors: Ron COHEN, Ness Ziona (IL); William Brad MATTHEWS, Los Gatos, CA (US); Rami ZEMACH, Givat Shapira (IL)

(21) Appl. No.: 19/280,990

(22) Filed: Jul. 25, 2025

Related U.S. Application Data
(60) Provisional application No. 63/675,676, filed on Jul. 25, 2024.

(51) Int. Cl. H04L 41/16; H04L 69/22

(52) U.S. Cl. CPC H04L 41/16; H04L 69/22

(57) ABSTRACT

A leaf network switch in a machine learning system receives one or more first messages from one or more network devices, the one or more first messages corresponding to a machine learning operation. The leaf network switch determines one or more processing operations to be performed by the leaf network switch in connection with the one or more first messages. The leaf network switch performs the one or more processing operations, including generating a second message based on the one or more first messages, and transmitting the second message to another network switch. The leaf network switch receives a third message from the other network switch. The leaf switch replicates the third message to generate multiple instances of the third message, and transmits the multiple instances of the third message to respective network devices.

### CROSS REFERENCES TO RELATED APPLICATIONS

This application claims the benefit of U.S. Provisional Patent App. No. 63/675,676, entitled “Simpler INC Push Protocol at All Hops,” filed on Jul. 25, 2024, the disclosure of which is expressly incorporated herein by reference in its entirety.

### FIELD OF TECHNOLOGY

The present disclosure relates generally to communication networks, and more particularly to communication networks for machine learning applications.

### BACKGROUND

The approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Some networking applications require switching between a very large number of ports. For example, a typical data center includes i) a large number of network devices such as servers, graphical processing units (GPUs), storage devices, etc., and ii) network switches to interconnect the network devices and to communicatively couple the network devices to outside network connections, such as backbone network links. As another example, some artificial intelligence/machine learning (AI/ML) systems comprise a large number of processors (e.g., GPUs) that are interconnected by a multi-tiered network. In such applications, switching systems capable of switching between numerous processors are utilized so that traffic can be forwarded between servers, GPUs, backbone network lines, etc. Such switching systems can include a large number of network switches.

In data centers, server farms, AI systems, etc., multiple layers of switches are often utilized, where a first layer of switches interconnects a second layer of switches, and where the second layer of switches are connected to processors, servers, storage devices, etc. In some systems, endpoint devices (e.g., processors, servers, storage devices, etc.), are organized into racks and further into rows of racks. To facilitate data communication among the endpoint devices, network switches are often deployed into the racks (e.g., top of rack switches), as well as between the racks. As such, data traversing a network within the system may travel through multiple layers of network switches between various stages of communication, storage, and processing.

### SUMMARY

In an embodiment, a leaf network switch for routing traffic in a machine learning system, comprising: a plurality of network interfaces; one or more processors configured to: receive one or more first messages from one or more network devices amongst a plurality of network devices communicatively connected to a first subset of the plurality of network interfaces, the one or more first messages corresponding to a machine learning operation, each of the one or more first messages including respective header information, the respective header information including machine learning information corresponding to the machine learning operation, determine one or more processing operations to be performed by the leaf network switch in connection with the one or more first messages, including determining the one or more processing operations using the machine learning information, perform the one or more processing operations, including generating a second message based on the one or more first messages, and transmitting the second message to another network switch communicatively connected to a second subset of the plurality of network interfaces, receive a third message from the other network switch, the third message corresponding to the machine learning operation, replicate the third message to generate a plurality of instances of the third message, and transmit the plurality of instances of the third message to respective network devices amongst the plurality of network devices via the first subset of the plurality of network interfaces.

In another embodiment, A method for routing traffic in a machine learning system, the method comprising: receiving, at a leaf network switch, one or more first messages from one or more network devices amongst a plurality of network devices communicatively connected to the leaf network switch, the one or more first messages corresponding to a machine learning operation, each of the one or more first messages including respective header information, the respective header information including machine learning information corresponding to the machine learning operation; determining, at the leaf network switch, one or more processing operations to be performed by the leaf network switch in connection with the one or more first messages, including determining the one or more processing operations using the machine learning information; performing, by the leaf network switch, the one or more processing operations, including generating a second message based on the one or more first messages, and transmitting the second message to another network switch; receiving, at the leaf network switch, a third message from the other network switch, the third message corresponding to the machine learning operation; replicating, at the leaf network switch, the third message to generate a plurality of instances of the third message; and transmitting, by the leaf network switch, the plurality of instances of the third message to respective network devices amongst the plurality of network devices.

### BRIEF DESCRIPTION OF THE DRAWINGS

FIG. 1 is a simplified diagram of an example machine learning system that includes a computational processors interconnected by an example multi-tiered network having a plurality of network switches that interoperate according to a communication protocol for machine learning applications, according to an embodiment.

FIG. 2 is a simplified diagram of an example collective of members within the machine learning system of FIG. 1, according to an embodiment.

FIG. 3 is a simplified diagram of an example network switch of the machine learning system of FIG. 1, in an embodiment.

FIG. 4 is a simplified diagram illustrating example communication protocol operations corresponding to a machine learning operation, according to an embodiment.

FIG. 5 is a simplified diagram of an example packet format of the messages exchanged by network devices in the machine learning system of FIG. 1, according to an embodiment.

FIG. 6 is a simplified diagram illustrating example communication protocol operations corresponding to another machine learning operation, according to another embodiment.

FIG. 7 is a simplified diagram illustrating example communication protocol operations corresponding to another machine learning operation, according to another embodiment.

FIG. 8 is a simplified diagram illustrating example communication protocol operations corresponding to another machine learning operation, according to another embodiment.

FIG. 9 is a simplified flow diagram of an example method for routing traffic in the machine learning system of FIG. 1, according to an embodiment.

### DETAILED DESCRIPTION

In some machine learning applications, a group of members (e.g., computers, processors, GPUs, servers, etc.) work collectively to perform a processing task. Such a group is sometimes referred to as a “collective.” Processing tasks in machine learning applications involve one or more of i) dividing processing tasks amongst members; ii) performing computations on subsets of data to generate intermediate results; iii) aggregating intermediate results into a final result; etc., according to some embodiments. Members of the collective are communicatively coupled via a communication network.

In some embodiments, processing tasks in machine learning applications additionally or alternatively involve one or more of performing a processing operation that involves reducing a set of numbers into a smaller set of one or more numbers according to a function (sometimes referred to as a “reduce” operation). Examples of the function that reduces the set of numbers include one or more of i) selecting a maximum number from the set of numbers; ii) selecting a minimum number from the set of numbers; iii) calculating a sum of the numbers in the set; iv) calculating an average of the numbers in the set; v) calculating a product of the numbers in the set; vi) performing a logical AND of the numbers in the set to generate a result; vii) performing a logical OR of the numbers in the set to generate a result; viii) performing a bitwise AND of the numbers in the set to generate a result; ix) performing a bitwise OR of the numbers in the set to generate a result; etc., according to various embodiments.

In some embodiments, processing tasks in machine learning applications additionally or alternatively include a reduce operation in which the smaller set of one or more numbers is sent to all members of the collective, which is sometimes referred to as an “all_reduce” operation.

In some embodiments, processing tasks in machine learning applications additionally or alternatively include one or more of i) a root member sending a same piece of data to other members of the collective (sometimes referred to as a “broadcast” operation; ii) the root member sending respective data to the other members of the collective (sometimes referred to as a “scatter” operation); iii) the other members of the collective sending respective data to the root member (sometimes referred to as a “gather” operation); iv) each member of the collective sending respective data to each other member (sometimes referred to as an “all_gather” operation); etc., according to some embodiments.

In some embodiments, processing tasks in machine learning applications additionally or alternatively include members sending signals to indicate to other members of the collective that the members have reached a known point in a machine learning process (sometimes referred to as a “barrier” operation). In a barrier operation, a member will, upon reaching a known point in a machine learning process, send a barrier message and wait until the member determines that all other members have also transmitted barrier messages. A barrier operation is useful for synchronizing operations of members of the collective, for example, at least in some embodiments.

In some embodiments, the communication network is configured to support machine learning operations by performing processing operations corresponding to the machine learning operations such as one or more of: i) network switches of the communication network executing one or more functions that reduce a set of numbers into a smaller set of one or more numbers; ii) network switches replicating a message corresponding to a machine learning operation and sending the replicated message to multiple members; iii) network switches compiling data from multiple members and sending the compiled data to another member; etc. In some such embodiments, traffic in the communication network is reduced and/or machine learning operation execution time is reduced when network switches of the communication network perform processing operations corresponding to the machine learning operations such as described above. With respect to a broadcast operation, for example, a root member need not generate multiple instances of a message and send the multiple instances into the communication network. Rather, the root member need only send a single instance of the message into the communication network, and the communication network will replicate the message at one or more later stages, in some embodiments. With respect to a reduce operation, as another example, respective input data from multiple members need not be forwarded to a root member. Rather, each of multiples network switches receives multiple inputs, computes a result, and forwards the result rather than the multiple inputs, in some embodiments.

In some embodiments, the communication network comprises a plurality of layers of network switches. For example, a lowest layer of network switches are communicatively connected to members (e.g., computers, processors, GPUs, servers, etc.), and one or more upper layers of network switches communicatively interconnect network switches of the lowest layer. The network switches of the lowest layer are sometimes referred to as “leaf” switches, and the network switches 124 of a highest layer are sometimes referred to as “spine” switches. In some embodiments, the communication network includes one or more intermediate layers of switches between the lowest layer and the highest layer that interconnect the leaf switches of the lowest layer with the spine switches of the highest layer.

One approach to communicating machine learning information in systems such as described above involves each leaf switch receiving messages corresponding to machine learning operations from upstream network switches, converting the messages from a format used in connection with exchanging messages amongst network switches of the communication network (sometimes referred to as an in-network computing (INC) format) to remote memory access (RMA) write messages, and sending the RMA write messages to endpoint network devices (e.g., computers, processors, GPUs, servers, etc.) corresponding to members of collectives. To convert a message in the INC format (sometimes referred to as an “INC message”) to an RMA write message for an endpoint network device, a leaf switch uses state information from an INC message previously received from the endpoint network device. As an illustrative example, a leaf switch receives a first INC message from an endpoint network device in connection with a machine learning operation, and the leaf switch forwards the first INC message (or another INC message generated by the leaf switch using the first INC message) to an upstream switch. The leaf switch stores state information included in the first INC message in association with an indicator of the machine learning operation. Subsequently, the leaf switch receives a second INC message corresponding to the machine learning operation from the upstream switch, and uses the previously stored state information from the first INC message to convert the second INC message to an RMA write message.

Such INC message to RMA write message conversion increases complexity and cost of the leaf switch. For example, memory is required on the leaf switch to store the state information described above. Additionally, logic circuitry and/or processor capacity is required to retrieve state information corresponding to a particular machine learning operation from the memory, and perform the conversion using the retrieved state information.

In embodiments described below, a leaf switch forwards an INC message received from an upstream switch to an endpoint network device (e.g., a computer, a processor, a GPU, a server, etc.) instead of converting the INC message to an RMA write message and sending the RMA write message to the endpoint network device. At least in some embodiments, forwarding the INC message to the endpoint network device reduces complexity and/or cost of the leaf switch reduces complexity and/or cost of the leaf switch as compared to a leaf switch that converts the INC message to an RMA write message and sends the RMA write message to the endpoint network device.

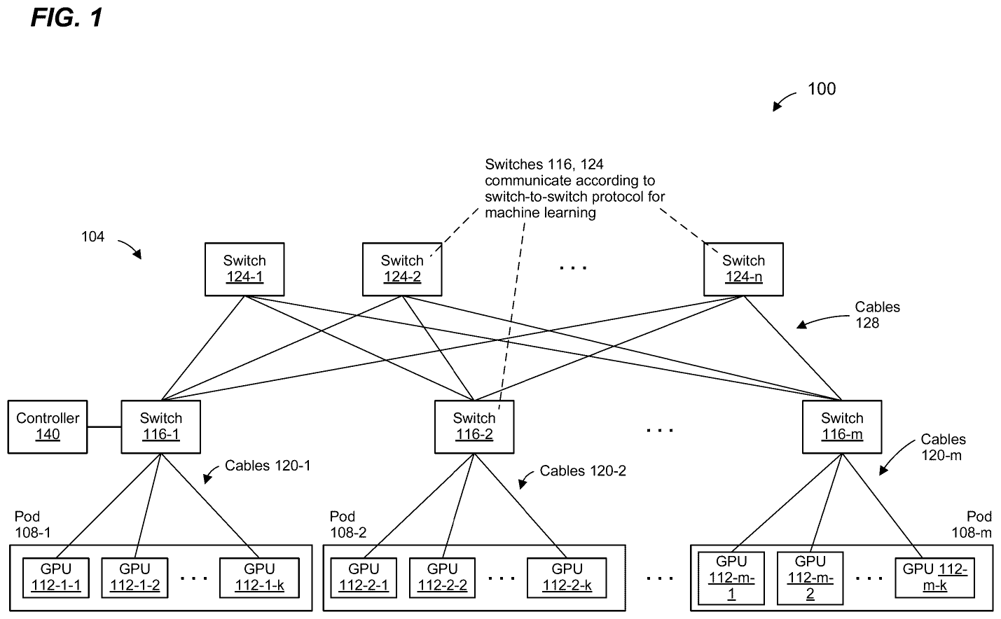

FIG. 1 is a simplified diagram of an example machine learning system 100 that includes computational processors interconnected by an example multi-tiered communication network 104 having a plurality of network switches, according to an embodiment. For example, the network 104 is coupled to a plurality of computational pods 108, each computational pod comprising a plurality of computational processors 112, such as graphical processing units (GPUs) or other suitable processors. In an embodiment, the number of computational pods 108 is m, where m is a suitable positive integer. In an embodiment, each pod 108 corresponds to respective rack in the machine learning system 100. In another embodiment, each pod 108 corresponds to respective set of multiple racks in the machine learning system 100. In another embodiment, respective sets of multiple pods 108 correspond to a respective rack in the machine learning system 100. In other embodiments, at least some of the computational processors 112 are not organized in racks.

In an embodiment, each of at least some of the computational processors 112 includes a GPU, and the computational processors 112 are sometimes referred to herein as GPUs 112 for ease of explanation. In other embodiments, each of at least some of the computational processors 112 includes a suitable processor other than a GPU, such as a central processing unit (CPU), a digital signal processor (DSP), a graph processor, etc. In some embodiments, at least some of the GPUs 112 are replaced by other suitable network devices such as memory devices, network switches, etc.

In an embodiment, the number of GPUs 112 in each computational pod 108 is k, where k is a suitable positive integer. In an embodiment, each computational pod 108 includes a same number of GPUs 112. In another embodiment, at least some computational pods 108 include different numbers of GPUs 112.

Each computational pod 108 is communicatively coupled to a respective network switch 116 of the network 104. For example, each GPU 112 of the computational pod 108 is communicatively coupled to the respective network switch 116 via one or more suitable cables 120 such as electrical cables, optical cables, etc. In an embodiment, each GPU 112 includes (or is coupled to) one or more ports (not shown; e.g., electrical ports, optical ports, etc.) that are configured to couple to the one or more cables 120 and to communicate at data rates that are suitable for machine learning applications. The one or more ports of the GPU 112 are communicatively coupled to the network switch 116 via the one or more cables 120.

In an embodiment, each network switch 116 includes a plurality of ports (sometimes referred to herein as “downlink ports”; not shown; e.g., electrical ports, optical ports, etc.) to which the communication cables 120 are connected. Each of at least some of the downlink ports is configured to communicate at data rates suitable for machine learning applications. In an embodiment, the network switch 116 includes a number of downlink ports that is equal to or greater than the number of GPUs 112 in the computational pod 108. In an embodiment, each network switch 116 includes a same number of downlink ports. In another embodiment, at least some network switches 116 include different numbers of downlink ports.

In an embodiment, each network switch 116 corresponds to a top of rack (TOR) switch. In another embodiment, one or more (or all) network switches 116 are not TOR switches.

Each network switch 116 is communicatively coupled to a plurality of network switches 124 by a plurality of communication cables 128 (e.g., electrical cables, optical cables, etc.). In an embodiment, the cables 128 are rated for data rates suitable for machine learning applications. In an embodiment, each network switch 116 includes a plurality of ports (sometimes referred to herein as “uplink ports”; not shown; e.g., electrical ports, optical ports, etc.) to which the communication cables 128 are connected. Each of at least some of the uplink ports is configured to communicate at data rates suitable for machine learning applications.

Each of at least some of the network switches 124 is communicatively coupled to the plurality of network switches 116, in some embodiments. In an embodiment, each network switch 124 includes a plurality of ports (not shown; e.g., electrical ports, optical ports, etc.) to which the communication cables 128 are connected. Each of at least some of the ports is configured to communicate at data rates suitable for machine learning applications. For each of at least some of the network switches 124, a number of ports is at least the same as the number of network switches 116. Thus, in the example illustrated in FIG. 1 in which there are m network switches 116, each of at least some of the network switches includes at least m ports. In another embodiment, the number of ports of each network switch 124 is a suitable number greater than or equal to m. In an embodiment, each network switch 124 includes a same number of ports. In another embodiment, at least some network switches 124 include different numbers of ports.

In other embodiments, each of at least some of the network switches 124 is communicatively coupled to the less than all of the network switches 116. In some such embodiments, the number of ports of each of at least some of the network switches 124 is a suitable number less than m.

The example communication network 104 includes two layers of switches, i.e., a lowest layer comprising the network switches 116 and a highest layer comprising the network switches 124. The network switches 116 of the lowest layer are sometimes referred to as “leaf” switches, and the network switches 124 of the highest layer are sometimes referred to as “spine” switches. In other embodiments, the communication network 104 includes one or more intermediate layers of switches between the lowest layer and the highest layer that interconnect the lowest layer with the highest layer.

In some machine learning applications, a group of members (e.g., computers, processors, GPUs, etc.) work collectively to perform a processing task. Such a group is sometimes referred to as a “collective.” Processing tasks in machine learning applications involve one or more of i) dividing processing tasks amongst members; ii) members performing computations on subsets of data to generate intermediate results; iii) aggregating intermediate results into a final result; etc., according to some embodiments.

In some embodiments, processing tasks in machine learning applications additionally or alternatively include one or more reduce operations such as described above. To facilitate processing tasks in machine learning applications, a communication network, such as the communication network 104, is configured to support one or more of i) a broadcast operation; ii) a scatter operation; iii) a gather operation; iv) an all_gather operation; etc., according to some embodiments. In various embodiments, each of at least some of the network switches 116, 124 is configured to support one or more of i) broadcast operations, ii) scatter operations, iii) gather operations, iv) all_gather operations, etc.

In some embodiments, a communication network, such as the communication network 104, is additionally or alternatively configured to support members of a collective performing a barrier operation. In some embodiments, each of at least some of the network switches 116, 124 is configured to support barrier operations.

In some embodiments, each of at least some of the network switches 116, 124 is additionally or alternatively configured to support reduce operations. For instance, each of at least some of the network switches 116, 124 includes a respective processor that is configured to perform one or more functions that reduce a set of numbers into a smaller set of one or more numbers, in some embodiments. In some such embodiments, the network switch 116, 124 receives the set of numbers from multiple GPUs 112 or from multiple other switches, generates the smaller set of one or more numbers, and forwards the smaller set of one or more numbers to another switch or a GPU 112.

In some embodiments, each of at least some of the network switches 116, 124 is additionally or alternatively configured to support a reduce operation in which the network switch 116, 124 sends the smaller set of one or more numbers to all members of the collective, which is sometimes referred to as an “all_reduce” operation. In some such embodiments, the network switch 116, 124 receives the set of numbers from multiple GPUs 112 or from multiple other switches, generates the smaller set of one or more numbers, and forwards the smaller set of one or more numbers to one or more other switches or multiple GPUs 112.

In some embodiments, each of at least some of the network switches 116, 124 is additionally or alternatively configured to support an operation in which the network switch 116, 124 sends the smaller set of one or more numbers to all members of the collective, which is sometimes referred to as an “all_reduce” operation.

The system also includes a network controller 140 communicatively coupled to the network switch 116-1. In an embodiment, the network controller 140 is communicatively coupled to a port of the network switch 116-1 via a suitable cable. In another embodiment, the network controller 140 is communicatively coupled to a management interface of the network switch 116-1. In another embodiment, the network controller 140 is communicatively coupled to one of the network switches 124. In another embodiment, the network controller 140 is communicatively coupled to all of the network switches 116, 124.

The network controller 140 is configured to communicate with all of the network switches 116, 124 via one of the switches to which the network controller 140 is communicatively connected (e.g., the switch 116-1), or directly when the network controller 140 is communicatively connected to all of the network switches 116, 124, e.g., via respective management interfaces of the network switches 116, 124.

The network controller 140 is configured to organize groups of GPUs 112 to collectively perform processing tasks associated with machine learning operations and/or to inform the network switches 116, 124 of the membership of the groups, in some embodiments. The network controller 140 is configured to organize collectives of members (e.g., GPUs 112) and/or to inform the network switches 116, 124 of the membership of the collectives, in some embodiments.

In an embodiment, in connection with members joining a group (e.g., a collective) for collectively performing machine learning operations, the network controller 140 determines a suitable tree topology for the group, and configures the network switches 116, 124 corresponding to the tree topology, e.g., one or more of: informs the network switches 116, 124 in the tree topology of the group membership, provides to the network switches 116, 124 in the tree topology information regarding the tree vertices corresponding to the tree topology, informs the network switches 116, 124 in the tree topology of the group membership, provides to the network switches 116, 124 of the tree topology other information corresponding to the group, etc.

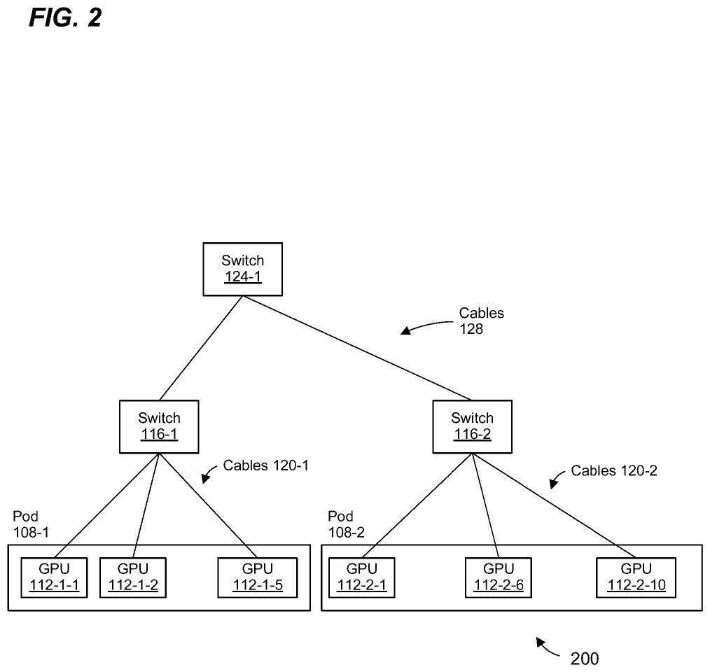

FIG. 2 is a simplified diagram of an example collective 200 within the system 100 of FIG. 1, according to an embodiment. The collective 200 includes GPU 112-1-1, GPU 112-1-2, GPU 112-1-5, GPU 112-2-1, GPU 112-2-6, and GPU 112-2-10. Thus, the collective 200 includes a subset of GPUs 112 from the pod 108-1 and a subset of GPUs 112 from the pod 108-2. In other embodiments, a collective includes GPUs 112 from more than two pods 108. Although FIG. 2 illustrates a collective 200 that includes a subset of GPUs 112 from a pod 108, a collective includes all of the GPUs 112 from one or more pods 108 in other embodiments.

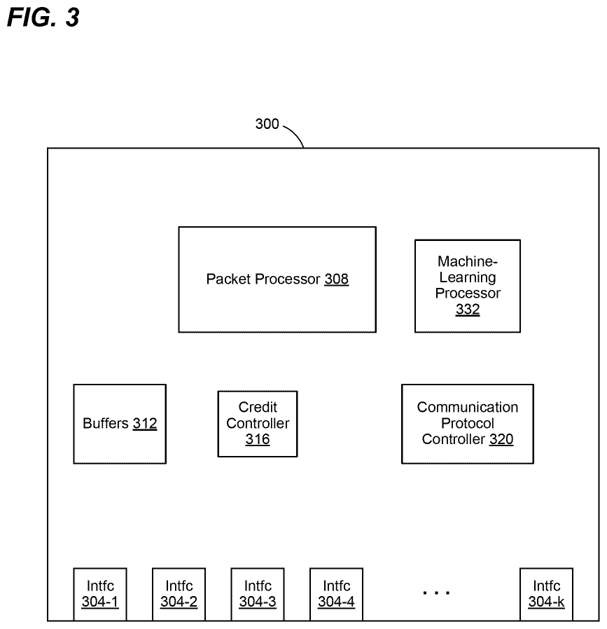

FIG. 3 is a simplified diagram of an example network switch 300 that is configured to operate in the machine learning system 100 of FIG. 1, in an embodiment. Each of at least some of the network switches 116, 124 have a structure the same as or similar to the network switch 300, in an embodiment. In other embodiments, the network switches 116, 124 have another suitable structure (or structures) different than the network switch 300, in an embodiment. In some embodiments, the network switch 300 is included in another suitable system different than the machine learning system 100.

The network switch 300 includes a plurality of network interfaces 304 that are configured to communicatively couple with suitable communication media, such as electrical cables, optical cables, free space, etc. A packet processor 308 is configured to forward packets, received via the network interfaces 304, amongst the network interfaces 304. For example, the packet processor 308 is configured to analyze at least headers of packets received via the network interfaces 304 to determine network interfaces 304 via which the packets are to be forwarded.

The network switch 300 also includes buffers 312 for storing packet data corresponding to packets received via the network interfaces 304 and packet data corresponding to packets that are to be transmitted via the network interfaces 304.

A credit controller 316 is configured to manage credits associated with receiving packets from other network devices (e.g., GPUs, other network switches, etc.) and transmitting packets to the other network devices. For example, for each of one or more other network devices, the credit controller 316 maintains a set of credits corresponding to the network device and monitors at least some of the buffers 312. When credit controller 316 determines that a buffer 312 is ready to receive packets from the other network device, the credit controller 316 prompts the network switch 300 to transmit credits that correspond to the buffer 312 to the other network device to inform the other network device that the network switch 300 can receive packets from the other network device, in an embodiment. The other network device expends the credits when transmitting packets to the network switch 300, and when the other network device is out of the credits the other network device is not permitted to transmit packets to the network switch 300.

As another example, for each of one or more other network devices, the credit controller 316 maintains a count of credits corresponding to the other network device. For example, the network switch 300 receives credits from the other network device that informs the network switch 300 that the other network device can receive packets from the network switch 300, and in response to receiving the credits, the credit controller 316 increments the credits corresponding to the other network device, in an embodiment. When there are credits available for transmitting to the other network device, the credit controller 316 permits the network switch 300 to transmit packets to the other network device, and the credit controller 316 decrements the count of credits in connection with transmitting packets to the other network device. When there are no credits available for transmitting to the other network device, the credit controller 316 prevents the network switch 300 from transmitting packets to the other network device. Subsequently, when the network switch 300 receives credits from the other network device, the credit controller 316 increments the count of credits corresponding to the other network device.

The network switch 300 also includes a communication protocol controller 320 that is configured to control the network switch 300 to operate according to a communication protocol. The communication protocol governs operation of the network switches 116, 124 in connection with one or more of i) broadcast operations, ii) scatter operations, iii) gather operations, iv) all_gather operations, v) reduce operations, vi) all_reduce operations, vii) barrier operations, etc. The communication protocol controller 320 is a component of the packet processor 308, in an embodiment. In another embodiment, the communication protocol controller 320 is distinct from the packet processor 308.

The network switch 300 further includes a machine learning processor 332 that is configured to perform processing operations corresponding to one or more machine learning applications. For instance, the machine learning processor 332 is configured to perform one or more reduce operations, in some embodiments. In some such embodiments, the network switch 300 receives the set of numbers from multiple other network devices, generates a smaller set of one or more numbers, and forwards the smaller set of one or more numbers to one or more other network devices.

In various embodiments, the machine learning processor 332 is configured to perform one or more processing operations that involve one or more of i) selecting a maximum number from a set of numbers received from multiple other network devices; ii) selecting a minimum number from the set of numbers; iii) calculating a sum of the numbers in the set; iv) calculating an average of the numbers in the set; v) calculating a product of the numbers in the set; vi) performing a logical AND of the numbers in the set to generate a result; vii) performing a logical OR of the numbers in the set to generate a result; viii) performing a bitwise AND of the numbers in the set to generate a result; ix) performing a bitwise OR of the numbers in the set to generate a result; etc.

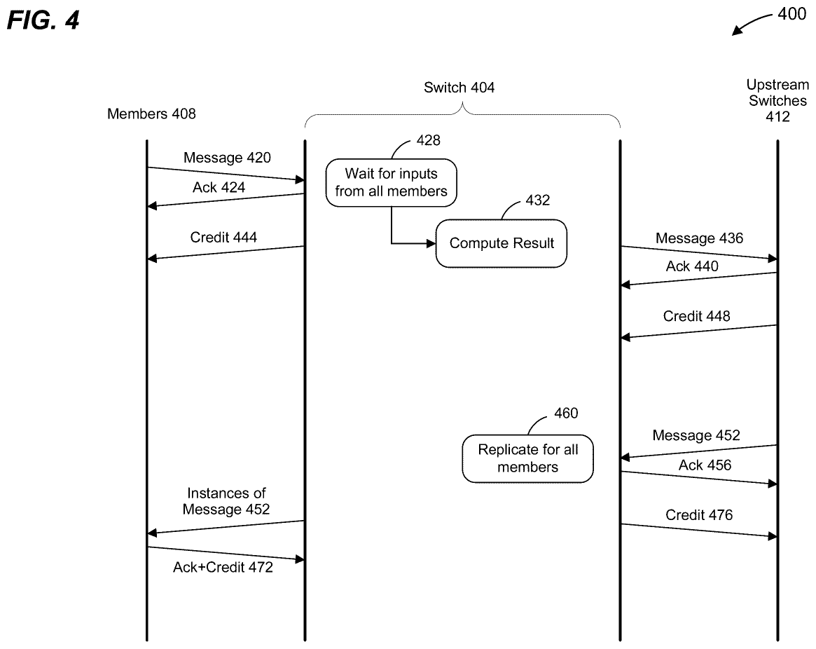

FIG. 4 is a simplified diagram 400 illustrating communication protocol operations corresponding to an all_reduce operation, according to an embodiment. The communication protocol operations illustrated in FIG. 4 are performed in the system 100 of FIG. 1, in an embodiment, and FIG. 4 is described with reference to FIG. 1 for ease of explanation. In another embodiment, the communication protocol operations illustrated in FIG. 4 are performed in another suitable system different than the system 100. The network switch 300 of FIG. 3 performs some of the communication protocol operations illustrated in FIG. 4, in an embodiment, and FIG. 4 is described with reference to FIG. 3 for ease of explanation. In other embodiments, another suitable network switch different than the network switch 300 performs communication protocol operations illustrated in FIG. 4.

In the diagram 400, time increases in a direction from the top of the figure to the bottom of the figure.

In FIG. 4, a network switch 404 communicates with a plurality of members 408 and one or more upstream switches 412. For example, the network switch 116-1 communicates with the GPUs 112-1 and one or more of the upstream switches 124.

The network switch 404 receives a plurality of messages 420 from the members 408. The messages 420 correspond to an all_reduce operation and include input data that is to be processed as part of the all_reduce operation. The network switch 404 stores the messages 420 in buffers (e.g., buffers 312) of the network switch 404.

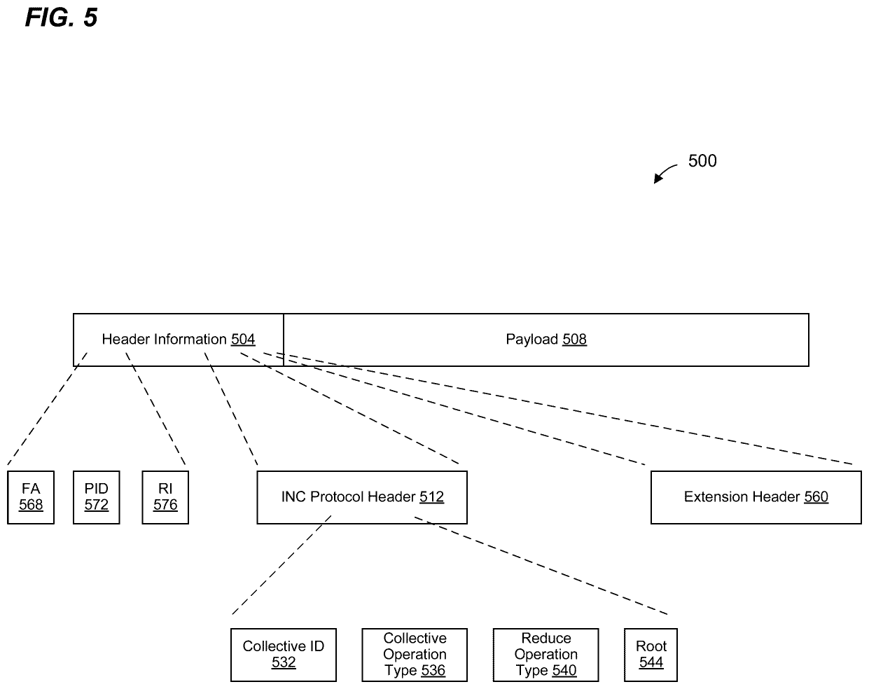

FIG. 5 is a simplified diagram of an example packet format 500 of the messages 420, according to an embodiment. In other embodiments, the messages 420 have another suitable format different than the packet format 500. In some embodiments, messages exchanged as part of a communication protocol that operates differently than the communication protocol operations illustrated in FIG. 4 have the packet format 500.

The packet format 500 includes header information 504 and payload information 508. The header information 504 includes communication protocol header information 512. The communication protocol header information 512 includes one or more of: i) collective identifier (ID) information 532, ii) a collective operation type indicator 536, iii) a reduce operation type indicator 540, iv) a root indicator 544, etc. The collective ID information 532 identifies a group of computational processors (e.g., GPUs 112) to which the packet corresponds, in an embodiment. In an embodiment, the collective ID information 532 comprises a collective sequence number that is specific to a particular machine learning process that is being performed by a group of members. In another embodiment, the collective ID information 532 comprises a collective sequence number that is specific to a particular group of members. In another embodiment, the collective ID information 532 comprises a collective sequence number that is specific to i) a particular group of members and ii) a particular machine learning process that is being performed by the particular group of members.

The collective operation type indicator 536 indicates a type of machine learning operation to which the packet corresponds from among a set of different types of machine learning operations (e.g., a set comprising two or more of i) broadcast operations, ii) scatter operations, iii) gather operations, iv) all_gather operations, v) reduce operations, vi) all_reduce operations, vii) barrier operations, etc., in various embodiments).

When the collective operation type indicator 536 indicates a reduce operation or an all_reduce operation, the reduce operation type indicator 540 indicates a type of function to be performed as part of the reduce operation to which the packet corresponds from among a set of different types of functions (e.g., a set comprising two or more of i) selecting a maximum number from the set of numbers; ii) selecting a minimum number from the set of numbers; iii) calculating a sum of the numbers in the set; iv) calculating an average of the numbers in the set; v) calculating a product of the numbers in the set; vi) performing a logical AND of the numbers in the set to generate a result; vii) performing a logical OR of the numbers in the set to generate a result; viii) performing a bitwise AND of the numbers in the set to generate a result; ix) performing a bitwise OR of the numbers in the set to generate a result; etc., according to various embodiments). In an embodiment, when the collective operation type indicator 536 indicates an operation that is not a reduce operation or an all_reduce operation, the reduce operation type indicator 540 is set to a reserved value.

At least when packet corresponds to a machine learning operation that involves a root member, the root indicator 544 is set to indicate whether the packet was transmitted by the root member. In an embodiment, when the collective operation type indicator 536 indicates an operation that does not involve a root member (e.g., an all_scatter operation, an all_reduce operation, a barrier operation, etc.), the root indicator 544 is set to a reserved value.

The header information 504 also optionally includes an extension header 560. In some scenarios, the extension header 560 includes information that indicates a region in a memory of an endpoint device that transmitted the packet 500. In a system in which leaf switches convert INC messages to RMA write messages, a leaf switch stores state information (e.g., the information that indicates the region in a memory of the endpoint device) included in the extension header 560 for conversion of a subsequent INC message received from an upstream switch to an RMA write message. As described herein, however, a leaf switch that does not convert INC messages to RMA write messages need not store state information included in the extension header 560, at least in some embodiments. In fact, messages 420 received from members 408 omit the extension header 560, at least in some embodiments.

The header information 504 also includes a fabric endpoint (FEP) address (FA) 568 corresponding to a destination FEP, a process identifier (PID) corresponding to the destination FEP (sometimes referred to as an “PIDonFEP”) 572, and a resource index (RI) 576 that indicates a particular subroutine, function, etc., corresponding to the PIDonFEP 572.

Referring now to FIGS. 4 and 5, when the messages 420 have the packet format 500, each payload 508 includes respective input data that is to be processed as part of the all_reduce operation; the collective ID information 532 is set to indicate a collective corresponding to the members 408; the collective operation type information 536 is set to indicate an all-reduce type of operation; the reduce operation type information type information 540 is set to indicate a particular function type from a set of multiple possible types of functions (e.g., a set comprising two or more of i) selecting a maximum number from the set of numbers; ii) selecting a minimum number from the set of numbers; iii) calculating a sum of the numbers in the set; iv) calculating an average of the numbers in the set; v) calculating a product of the numbers in the set; vi) performing a logical AND of the numbers in the set to generate a result; vii) performing a logical OR of the numbers in the set to generate a result; viii) performing a bitwise AND of the numbers in the set to generate a result; ix) performing a bitwise OR of the numbers in the set to generate a result; etc., according to various embodiments); and the root indicator 544 is set to a reserved value, in an embodiment.

In response to receiving each message 420, the network switch 404 transmits a respective acknowledgment message 424 to the respective member 408 to acknowledge receiving the message 420. For example, the communication protocol controller 320 prompts the network switch 404 to transmit a respective acknowledgment message 424 to the respective member 408 to acknowledge receiving each message 420, in an embodiment.

As discussed above, the network switch 404 does not store state information included in the extension header 560, at least in some embodiments. In fact, messages 420 received from members 408 omit the extension header 560, at least in some embodiments.

The network switch 404 waits (428) for messages 420 from all members 408 of the collective communicatively coupled to downlink ports of the network switch 404 before computing (432) a result using input data in the messages 420. For example, the communication protocol controller 320 uses the collective ID information 532 in the messages 420 to determine when the network switch 404 has received messages 420 from all members 408 that are communicatively coupled to downlink ports of the network switch 404, in an embodiment. In another embodiment, the communication protocol controller 320 uses the collective ID information 532 and the collective operation type information 536 in the messages 420 to determine when the network switch 404 has received messages 420 from all members 408 that are communicatively coupled to downlink ports of the network switch 404. In another embodiment, the switch-to-switch protocol controller 320 additionally or alternatively uses suitable header information 504 other than the collective ID information 532 and the collective operation type information 536 in the messages 420 to determine when the network switch 404 has received messages 420 from all members 408 that are communicatively coupled to downlink ports of the network switch 404.

In response to determining that the network switch 404 has received messages 420 from all members 408 of the collective that are communicatively coupled to downlink ports of the network switch 404, the network switch 404 computes (432) a result using input data in the messages 420. For example, the communication protocol controller 320 uses the reduce operation type information 540 in the messages 420 to determine a type of computation to be performed using the input data in the messages 420, and prompts the machine learning processor 332 to perform the computation on the input data to generate the result, in an embodiment.

When less than all members of the collective are communicatively coupled to downlink ports of the network switch 404, the result generated by the network switch 404 (e.g., by the machine learning processor 332) is an intermediate result that will be used by an upstream switch (along with one or more other intermediate results from one or more other switches) to compute a final result.

When the result generated (432) is an intermediate result, the network switch 404 generates a message 436 that includes the intermediate result. The message 436 has the packet format 500, in an embodiment, and the intermediate result is included in the payload 508. The network switch 404 generates (e.g., the communication protocol controller 320 generates) the message to include i) the same collective ID information 532 as included in the messages 420; ii) the same collective operation type information 536 as included in the messages 420; iii) and the same reduce operation type information 540 as included in the messages 420; in an embodiment.

In an embodiment, the network switch generates (e.g., the packet processor 308 generates, the communication protocol controller 320 generates, etc.) the message 436 according to an absolute addressing mode in which the PIDonFEP 572 and the RI 576 in the message 436 are set to the same values of the PIDonFEP 572 and the RI 576 in the messages 420. The message 436 is generated to omit the extension header information 560, in an embodiment.

The network switch 404 stores the message 436 in one or more buffers (e.g., one or more of the buffers 312) corresponding to one or more respective upstream switches 412 until the network switch 404 can transmit the message 436 to the one or more respective upstream switches 412. When the network switch 404 determines (e.g., when the credit controller 316 determines) that the network switch 404 has credits to transmit the message 436 to an upstream switch 412, the network switch 404 retrieves the message 436 from a corresponding buffer and transmits the message 436 to the upstream switch 412.

In an embodiment, the communication protocol controller 320 uses the collective ID information 532 in the message 436 to determine the upstream switches 412 to which the network device 404 is to transmit the message 436. In another embodiment, the switch-to-switch protocol controller 320 additionally or alternatively uses suitable header information 504 other than the collective ID information 532 in the message 436 to determine the upstream switches 412 to which the network device 404 is to transmit the message 436.

In response to the network switch 404 transmitting the message 436 to an upstream switch 412, the upstream switch 412 transmits an acknowledgment message 440 to the network switch 404 to confirm that the upstream switch 412 received the message 436.

In an embodiment, when the network switch 404 determines (e.g., the credit controller 316 determines) is able to receive further messages from the members 408 corresponding to the collective, the network switch 404 provides (e.g., the credit controller 316 prompts the network switch 404 to provide) the members 408 with credits for transmitting to the network switch 404. In an embodiment, the credit controller 316 prompts the communication protocol controller 320 to generate the credit messages 444; the communication protocol controller 320 then prompts the network switch 404 to transmit the credit messages 444 to the members 408 corresponding to the collective.

Subsequently, each of the one or more upstream switches 412 determines that the upstream switch 412 is able to receive further messages from the network switch 404. Thus, according to an embodiment, each of the upstream switches 412 subsequently transmits a respective credit messages 448 to the network device 404.

When the result generated (432) by the network switch 404 is an intermediate result, an upstream switch will eventually compute a final result using the intermediate result in the message 436 and one or more intermediate results from one or more other switches; and the network switch 404 receives a message 452 that includes the final result from one of the upstream switches 412. In response to receiving the message 452, the network switch 404 transmits an acknowledgement message 456 to confirm to the one upstream switch 412 receipt of the message 452.

The message 452 has the packet format 500, in an embodiment, and the final result is included in the payload 508. The message 452 includes i) the same collective ID information 532 as included in the messages 420; ii) the same collective operation type information 536 as included in the messages 420; and iii) the same reduce operation type information 540 as included in the messages 420, in an embodiment.

In an embodiment, the message 452 is generated according to an absolute addressing mode in which the PIDonFEP 572 and the RI 576 in the message 436 are set to the same values of the PIDonFEP 572 and the RI 576 in the messages 420. The message 452 omits the extension header information 560, in an embodiment.

The network switch 404 stores the message 452 in a buffer (e.g., one of the buffers 312) corresponding to the upstream switch 412 that transmitted the message 452, in an embodiment.

In an embodiment, the communication protocol controller 320 uses the collective ID information 532 in the message 452 to determine the members 408 to which the network device 404 is to transmit the final result. In another embodiment, the switch-to-switch protocol controller 320 additionally or alternatively uses suitable header information 504 other than the collective ID information 532 in the message 452 to determine the members 408 to which the network device 404 is to transmit the final result. The network switch 404 replicates (460) the message 452 so that instances of the message 452 are available for all members 408 that are to receive the final result. For example, the communication protocol controller 320 replicates (460) the message 452.

The multiple instances of the message 452 have the packet format 500, in an embodiment, and the final result is included in the payload 508. The multiple instances of the message 452 include i) the same collective ID information 532 as included in the messages 420; ii) the same collective operation type information 536 as included in the messages 420; and iii) the same reduce operation type information 540 as included in the messages 420, in an embodiment.

In an embodiment, the multiple instances of the message 452 are generated according to an absolute addressing mode in which the PIDonFEP 572 and the RI 576 in the message 436 are set to the same values of the PIDonFEP 572 and the RI 576 in the messages 420. The multiple instances of the message 452 omit the extension header information 560, in an embodiment.

As discussed above, the network switch 404 does not convert the instances of the message 452 to respective RMA write messages for transmission to the members 408 that are to receive the final result.

The network switch 404 stores each instance of the message 452 in a respective buffer (e.g., a respective buffer 312) corresponding to a member 408 until the network switch 404 can transmit the respective instance of the message 452 to the member 408. When the network switch 404 determines (e.g., when the credit controller 316 determines) that the network switch 404 has credits to transmit the respective instance of the message 452 to a member 408, the network switch 404 retrieves the respective instance of the message 452 from a corresponding buffer and transmits the respective instance of the message 452 to the member 408.

In response to the network switch 404 transmitting the instance of the message 452 to a member 408, the member 408 transmits an acknowledgment message 472 to the network switch 404 to confirm that the member 408 received the instance of the message 452.

The network switch 404 determines (e.g., the credit controller 316 determines) that the network switch 404 is able to receive further messages from the corresponding upstream switch 412, and thus the network switch 404 transmits a credit messages 476 to the upstream switch 412 that transmitted the message 452 to provide the upstream switch 412 with credits for transmitting to the network switch 404.

Additionally, each of the one or more members 408 determines that the member 408 is able to receive further messages from the network switch 404. Thus, according to an embodiment, each of the members 408 transmits respective credit information to the network device 404. In an embodiment, the credit information from each member 408 is included in the respective message 472. In another embodiment, the credit information from each member 408 is included in a respective credit message distinct from the respective message 472.

The input data, the intermediate data, and/or the result data for a collective operation such as discussed above may comprise an array of a specific length and a specific data type, in an embodiment. When the input data, intermediate data, and/or results data exceeds a maximum transmit unit size (MTU) of the communication network 104, the data may be transferred using i) a single message with a payload consisting of the entire array of the collective data type spanning multiple packets (i.e., the message corresponds to multiple packets), each with a size less than or equal to the MTU, and/or ii) using multiple messages each consisting of only one packet with a size less than or equal to the MTU, in various embodiments. Each packet carries a portion of the collective data array limited by the MTU size, in some embodiments. In an embodiment, only a last packet of a multi-packet message or a last message among multiple messages carrying the input/intermediate/results data may have a size less than the MTU. In an embodiment, the network controller 140 determines the MTU to be used by a collective group based on the capabilities of the communication network 104 and provides the MTU to each member when it joins a collective.

When a message corresponds to multiple packets, each packet has a format such as illustrated in FIG. 5. In an embodiment, when a message corresponds to multiple packets, the header information 504 of the multiple packets include information that indicates the multiple packets correspond to one message. For example, the header information 504 includes a message identifier that is the same for the multiple packets, in an embodiment. In an embodiment, the header information 504 also includes i) a start of message indicator that indicates whether the packet 500 is a first-occurring packet of the message, and ii) an end of message indicator that indicates whether the packet 500 is a last-occurring packet of the message.

Thus, in some embodiments, each message 420 corresponds to one or more packets corresponding to input data for the collective operation, each message 436 corresponds to one or more packets corresponding to intermediate data for the collective operation, and/or each message 452 corresponds to one or more packets corresponding to result data for the collective operation. Similarly, in some embodiments, each member 408 may transmit multiple messages 420 corresponding to input data for the collective operation, and the network switch 404 waits (428) to receive the respective multiple messages 420 from each member 408. Similarly, in some embodiments, the network switch 404 may transmit multiple messages 436 corresponding to intermediate data for the collective operation. Similarly, in some embodiments, the network switch 404 may receive multiple messages 452 corresponding to result data for the collective operation, and the and the network switch 404 replicates (460) each of the messages 452 among the multiple messages 452.

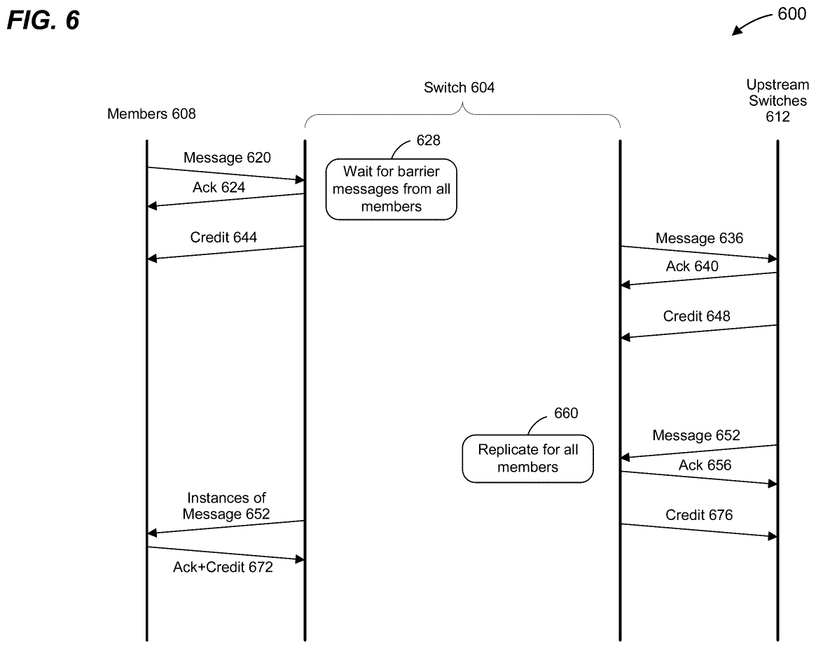

FIG. 6 is a simplified diagram 600 illustrating communication protocol operations corresponding to an all_reduce operation, according to another embodiment. The communication operations illustrated in FIG. 6 are performed in the system 100 of FIG. 1, in an embodiment, and FIG. 6 is described with reference to FIG. 1 for ease of explanation. In another embodiment, the communication protocol operations illustrated in FIG. 6 are performed in another suitable system different than the system 100. The network switch 300 of FIG. 3 performs some of the communication protocol operations illustrated in FIG. 6, in an embodiment, and FIG. 6 is described with reference to FIG. 3 for ease of explanation. In other embodiments, another suitable network switch different than the network switch 300 performs communication protocol operations illustrated in FIG. 6. The communication operations illustrated in FIG. 6 involve transmitting messages having the packet format 500 of FIG. 5, in an embodiment, and FIG. 6 is described with reference to FIG. 5 for ease of explanation. In another embodiment, the communication protocol operations illustrated in FIG. 6 involve transmitting messages having a suitable packet format different than the packet format 500.

In the diagram 600, time increases in a direction from the top of the figure to the bottom of the figure.

In FIG. 6, a network switch 604 communicates with a plurality of members 608 and one or more upstream switches 612. For example, the network switch 116-1 communicates with the GPUs 112-1 and one or more of the upstream switches 124.

The network switch 404 receives a plurality of messages 620 from the members 408 and stores the messages 420 in buffers (e.g., buffers 312) of the network switch 404. The messages 620 correspond to a barrier operation. When the messages 620 have the packet format 500, the collective ID information 532 is set to indicate a collective corresponding to the members 608; the collective operation type information 536 is set to indicate a barrier type of operation; the reduce operation type information 540 is set to a reserved value; and the root indicator 544 is set to a reserved value, in an embodiment. In an embodiment, the payload 508 of each message 620 is a zero byte payload.

In response to receiving each message 620, the network switch 604 transmits a respective acknowledgment message 624 to the respective member 608 to acknowledge receiving the message 620. For example, the communication protocol controller 320 prompts the network switch 604 to transmit a respective acknowledgment message 624 to the respective member 608 to acknowledge receiving each message 620, in an embodiment.

The network switch 404 does not store state information included in an extension header 560 of the messages 620, at least in some embodiments. In fact, messages 620 received from members 408 omit the extension header 560, at least in some embodiments.

The network switch 604 waits (628) for messages 620 from all members 608 of the collective communicatively coupled to downlink ports of the network switch 604. For example, the communication protocol controller 320 uses the collective ID information 532 in the messages 620 to determine when the network switch 404 has received messages 620 from all members 608 that are communicatively coupled to downlink ports of the network switch 604, in an embodiment. In another embodiment, the communication protocol controller 320 uses the collective ID information 532 and the collective operation type information 536 in the messages 620 to determine when the network switch 604 has received messages 620 from all members 608 that are communicatively coupled to downlink ports of the network switch 604. In another embodiment, the switch-to-switch protocol controller 320 additionally or alternatively uses suitable header information 504 other than the collective ID information 532 and the collective type information 536 in the messages 620 to determine when the network switch 604 has received messages 620 from all members 608 that are communicatively coupled to downlink ports of the network switch 604.

In response to determining that the network switch 604 has received messages 620 from all members 608 of the collective that are communicatively coupled to downlink ports of the network switch 604, the network switch 604 generates a barrier message 636. The barrier message 636 has the packet format 500, in an embodiment, and the payload 508 of the barrier message 636 is a zero byte payload. The network switch 604 generates (e.g., the communication protocol controller 320 generates) the message 636 to include i) the same collective ID information 532 as included in the messages 620; ii) the same collective operation type information 536 as included in the messages 620; iii) the same reduce operation type information 540 as included in the messages 620; and iv) the same root indication information 544 as included in the messages 620, in an embodiment.

In an embodiment, the network switch 404 generates (e.g., the packet processor 308 generates, the communication protocol controller 320 generates, etc.) the message 636 according to an absolute addressing mode in which the PIDonFEP 572 and the RI 576 in the message 636 are set to the same values of the PIDonFEP 572 and the RI 576 in the messages 620. The message 636 is generated to omit the extension header information 560, in an embodiment.

The network switch 404 stores the message 636 in one or more buffers (e.g., one or more of the buffers 312) corresponding to one or more respective upstream switches 612 until the network switch 604 can transmit the message 436 to the one or more respective upstream switches 612. When the network switch 604 determines (e.g., when the credit controller 316 determines) that the network switch 604 has credits to transmit the message 636 to an upstream switch 612, the network switch 604 retrieves the message 636 from a corresponding buffer and transmits the message 636 to the upstream switch 612.

In an embodiment, the communication protocol controller 320 uses the collective ID information 632 in the message 436 to determine the upstream switches 612 to which the network device 604 is to transmit the message 636.

In response to the network switch 604 transmitting the message 636 to an upstream switch 612, the upstream switch 612 transmits an acknowledgment message 640 to the network switch 604 to confirm that the upstream switch 612 received the message 636.

In an embodiment, when the network switch 604 determines that the network switch 604 is able to receive further messages from the members 608 corresponding to the collective, the network switch 604 transmits credit messages 644 to the members 608 corresponding to the collective to provide the members 608 with credits for transmitting to the network switch 604.

Subsequently, each of the one or more upstream switches 612 determines that the upstream switch 612 is able to receive further messages from the network switch 604. Thus, according to an embodiment, each of the upstream switches 612 subsequently transmits a respective credit messages 648 to the network device 604.

An upstream switch eventually determines, using the message 636 and one or more barrier messages from one or more other switches, that all members of the collective have transmitted barrier messages; and the upstream switch will in response issue a conclusive barrier message that indicates that all members of the collective have transmitted barrier messages. The network switch 604 receives, from one of the upstream switches 612, a message 652 that corresponds to the conclusive barrier message. In response to receiving the message 652, the network switch 604 transmits an acknowledgement message 656 to confirm to the one upstream switch 612 receipt of the message 652.

The message 652 has the packet format 500, in an embodiment, and the message 652 includes i) the same collective ID information 532 as included in the messages 620; ii) the same collective operation type information 536 as included in the messages 620; iii) the same reduce operation type information 540 as included in the messages 620; and iv) the same root indication information 544 as included in the messages 620, in an embodiment.

The network switch 604 stores the message 652 in a buffer (e.g., one of the buffers 312) corresponding to the upstream switch 612 that transmitted the message 652, in an embodiment.

In an embodiment, the message 652 is generated according to an absolute addressing mode in which the PIDonFEP 572 and the RI 576 in the message 436 are set to the same values of the PIDonFEP 572 and the RI 576 in the messages 436. The message 652 omits the extension header information 560, in an embodiment.

In an embodiment, the communication protocol controller 320 uses the collective ID information 532 in the message 652 to determine the members 608 to which the network device 404 is to transmit the conclusive barrier message. In another embodiment, the switch-to-switch protocol controller 320 additionally or alternatively uses suitable header information 504 other than the collective ID information 532 in the message 652 to determine the members 608 to which the network device 404 is to transmit the conclusive barrier message. The network switch 604 replicates (660) the message 652 so that instances of the message 652 are available for all members 408 that are to receive the conclusive barrier message. For example, the communication protocol controller 320 replicates (660) the message 652.

As discussed above, the network switch 604 does not convert the instances of the message 652 to respective RMA write messages for transmission to the members 608 that are to receive the final result.

The network switch 604 stores each instance of the message 652 in a respective buffer (e.g., a respective buffer 312) corresponding to a member 608 until the network switch 604 can transmit the respective instance of the message 652 to the member 608. When the network switch 604 determines (e.g., when the credit controller 316 determines) that the network switch 604 has credits to transmit the respective instance of the message 652 to a member 608, the network switch 604 retrieves the respective instance of the message 652 from a corresponding buffer and transmits the respective instance of the message 652 to the member 608.

In response to the network switch 604 transmitting the instance of the message 652 to a member 608, the member 608 transmits an acknowledgment message 672 to the network switch 604 to confirm that the member 608 received the instance of the message 652.

In an embodiment, the network switch 604 determines that the network switch 604 is able to receive further messages from the corresponding upstream switch 612, and the network switch 604 transmits a credit messages 676 to the upstream switch 612 that transmitted the message 652 to provide the upstream switch 612 with credits for transmitting to the network switch 604.

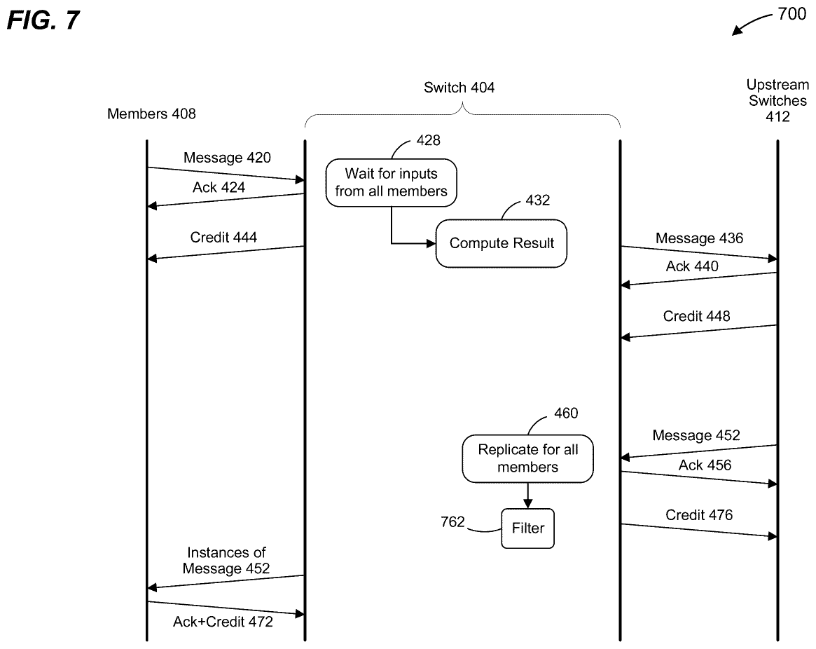

FIG. 7 is a simplified diagram 700 illustrating communication protocol operations corresponding to a reduce operation, according to another embodiment. The communication protocol operations illustrated in FIG. 7 are performed in the system 100 of FIG. 1, in an embodiment, and FIG. 7 is described with reference to FIG. 1 for ease of explanation. In another embodiment, the communication protocol operations illustrated in FIG. 7 are performed in another suitable system different than the system 100. The network switch 300 of FIG. 3 performs some of the communication protocol operations illustrated in FIG. 7, in an embodiment, and FIG. 7 is described with reference to FIG. 3 for ease of explanation. In other embodiments, another suitable network switch different than the network switch 300 performs communication protocol operations illustrated in FIG. 7. The communication protocol operations illustrated in FIG. 7 involve transmitting messages having the packet format 500 of FIG. 5, in an embodiment, and FIG. 7 is described with reference to FIG. 5 for ease of explanation. In another embodiment, the communication protocol operations illustrated in FIG. 7 involve transmitting messages having as suitable packet format different than the packet format 500.

In the diagram 700, time increases in a direction from the top of the figure to the bottom of the figure.

The operation illustrated in FIG. 7 is similar to the all_reduce operation of FIG. 4, and like-numbered elements are not described again in detail for purposes of brevity.

Referring now to FIGS. 7 and 5, when the messages 420 have the packet format 500, each payload 508 includes respective input data that is to be processed as part of the reduce operation; the collective ID information 532 is set to indicate a collective corresponding to the members 408; the collective operation type information 536 is set to indicate a reduce type of operation; the reduce operation type information type information 540 is set to indicate a particular function type from a set of multiple possible types of functions.

For the reduce operation, one of the members of the collective operates as a root, and thus the root indicator 544 in one of the messages 420 may be set to indicate the member 408 that transmitted the message 420 is the root; whereas as the root indicator 544 in the messages 420 that correspond to non-root members is set to indicate the member 408 that transmitted the message 420 is not the root.

In response to receiving a message 420 from one of the members 408 that indicates the member 408 is the root for the reduce operation, the network switch 404 stores (e.g., the communication protocol controller 320 stores) an indication of which member 408 is the root for the reduce operation, in an embodiment.

As discussed above, the message 436 has the packet format 500, in an embodiment, and the intermediate result is included in the payload 508. In an embodiment, when one of the members 408 is the root for the reduce operation, the network switch 404 generates (e.g., the communication protocol controller 320 generates) the message 436 to include the root indication information 544 set to indicate the message 436 corresponds to a root.

When the result generated (432) by the network switch 404 is an intermediate result, an upstream switch will eventually compute a final result using the intermediate result in the message 436 and one or more intermediate results from one or more other switches; and the network switch 404 receives the message 452 having the final result from one of the upstream switches 412.

The network switch 404 stores the message 452 in a buffer (e.g., one of the buffers 312) corresponding to the upstream switch 412 that transmitted the message 452, in an embodiment.

In an embodiment, the communication protocol controller 320 uses the collective ID information 532 in the message 452 to determine the members 408 to which the message 452 corresponds. In another embodiment, the switch-to-switch protocol controller 320 additionally or alternatively uses suitable header information 504 other than the collective ID information 532 in the message 452 to determine the members 408 to which the message 452 corresponds. The network switch 404 replicates (460) the message 452 so that instances of the message 452 are available for all members 408 of the collective. For example, the communication protocol controller 320 replicates (460) the message 452.

Because only the root is to receive the final result, the network switch 404 filters (762) the instances of the message 452. Filtering (762) the instances of the message 452 includes, for each non-root member 408, dropping packets corresponding to the final result except a last packet.

As discussed above, the network switch 404 does not convert the instances of the message 452 to respective RMA write messages for transmission to the members 408.

The network switch 404 stores each instance of the message 452 in a respective buffer (e.g., a respective buffer 312) corresponding to a member 408 until the network switch 404 can transmit the respective instance of the message 452 to the member 408. When the network switch 404 determines (e.g., when the credit controller 316 determines) that the network switch 404 has credits to transmit the respective instance of the message 452 to a member 408, the network switch 404 retrieves the respective instance of the message 452 from a corresponding buffer and transmits the respective instance of the message 452 to the member 408.

In an embodiment, the network device 404 determines (e.g., the communication protocol controller 320 determines) which member 408 is the root and which other members 408 are non-root members using the previously stored indication of which member 408 is the root for the reduce operation.

The network switch 404 stores each instance of the message 452 (after filtering) in a respective buffer (e.g., a respective buffer 312) corresponding to a member 408 until the network switch 404 can transmit the instance of the message 452 to the member 408. When the network switch 404 determines (e.g., when the credit controller 316 determines) that the network switch 404 has credits to transmit the message 768 to a member 408, the network switch 404 retrieves the instance of the message 452 from a corresponding buffer and transmits the instance of the message 452 to the member 408.

Performance of a broadcast operation is similar to the reduce operation described with reference to FIG. 7. Therefore, a broadcast operation will be described with reference to FIG. 7. In a broadcast operation, a root member distributes data to other members of the collective. Thus, the root member transmits a message 420 corresponding to the broadcast operation.

When the message 420 has the packet format 500, the payload 508 includes the data that is to be distributed as part of the broadcast operation; the collective ID information 532 is set to indicate a collective corresponding to the members 408; the collective operation type information 536 is set to indicate a broadcast type of operation; the reduce operation type information type information 540 is set to a reserved value, in an embodiment.

The root indicator 544 in the messages 420 from the root is set to indicate the member 408 that transmitted the message 420 is the root. In response to receiving the message 420, the network switch 404 stores (e.g., the communication protocol controller 320 stores) an indication of which member 408 is the root for the broadcast operation, in an embodiment.

Also in response to receiving the message 420, the network switch 404 generates and transmits (e.g., the communication protocol controller 320 generates and prompts the network switch 300 to transmit) the message 436, in an embodiment. Because the broadcast operation involves the root member distributing data to other members of the collective, the broadcast operation does not include waiting (428) for input data from all members of the collective, in an embodiment.

As discussed above, the message 436 has the packet format 500, in an embodiment, and the data to be distributed is included in the payload 508. In an embodiment, the network switch 404 generates (e.g., the communication protocol controller 320 generates) the message 436 to include the root indication information 544 set to indicate the message 436 corresponds to a root.

An upstream switch will generate and transmit the message 452 that includes the data to be distributed; and the network switch 404 receives the message 452 from one of the upstream switches 412.

The network switch 404 stores the message 452 in a buffer (e.g., one of the buffers 312) corresponding to the upstream switch 412 that transmitted the message 452, in an embodiment.

In an embodiment, the communication protocol controller 320 uses the collective ID information 532 in the message 452 to determine the members 408 to which the message 452 corresponds. In another embodiment, the switch-to-switch protocol controller 320 additionally or alternatively uses suitable header information 504 other than the collective ID information 532 in the message 452 to determine the members 408 to which the message 452 corresponds. The network switch 404 replicates (460) the message 452 so that instances of the message 452 are available for all members 408 of the collective. For example, the communication protocol controller 320 replicates (460) the message 452.

Because only the non-root members are to receive the data, the network switch 404 filters (762) the instances of the message 452. Filtering (762) the instances of the message 452 includes, for the root member 408, dropping packets corresponding to the data to be distributed except a last packet.

In an embodiment, the network device 404 determines (e.g., the communication protocol controller 320 determines) which member 408 is the root and which other members 408 are non-root members using the previously stored indication of which member 408 is the root for the reduce operation.

The network switch 404 stores each instance of the message 452 in a respective buffer (e.g., a respective buffer 312) corresponding to a member 408 until the network switch 404 can transmit the instance of the message 452 to the member 408. When the network switch 404 determines (e.g., when the credit controller 316 determines) that the network switch 404 has credits to transmit the message 768 to a member 408, the network switch 404 retrieves the instance of the message 452 from a corresponding buffer and transmits the instance of the message 452 to the member 408.

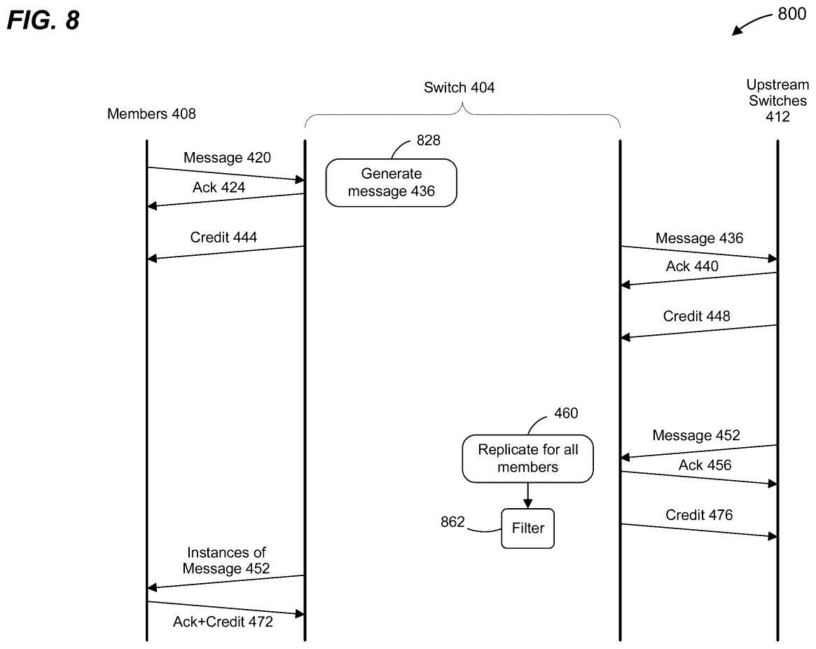

FIG. 8 is a simplified diagram 800 illustrating communication protocol operations corresponding to a scatter operation, according to another embodiment. The communication protocol operations illustrated in FIG. 8 are performed in the system 100 of FIG. 1, in an embodiment, and FIG. 8 is described with reference to FIG. 1 for ease of explanation. In another embodiment, the communication protocol operations illustrated in FIG. 8 are performed in another suitable system different than the system 100. The network switch 300 of FIG. 3 performs some of the communication protocol operations illustrated in FIG. 8, in an embodiment, and FIG. 8 is described with reference to FIG. 3 for ease of explanation. In other embodiments, another suitable network switch different than the network switch 300 performs communication protocol operations illustrated in FIG. 8. The communication protocol operations illustrated in FIG. 8 involve transmitting messages having the packet format 500 of FIG. 5, in an embodiment, and FIG. 8 is described with reference to FIG. 5 for ease of explanation. In another embodiment, the communication protocol operations illustrated in FIG. 8 involve transmitting messages having as suitable packet format different than the packet format 500.

In the diagram 800, time increases in a direction from the top of the figure to the bottom of the figure.

The operation illustrated in FIG. 8 is similar to the broadcast operation discussed with reference to FIG. 7, and like-numbered elements are not described again in detail for purposes of brevity.

Referring now to FIGS. 8 and 5, when the message 420 has the packet format 500, the payload 508 includes respective input data that is to distributed to respective other members of a collective as part of the scatter operation; the collective ID information 532 is set to indicate the collective corresponding to the members 408; the collective operation type information 536 is set to indicate a scatter type of operation; the reduce operation type information type information 540 is set to a reserved value, in an embodiment.

For the scatter operation, one of the members of the collective operates as a root, and the message 420 is issued by the root. Therefore, the root indicator 544 in the message 420 may be set to indicate the member 408 that transmitted the message 420 is the root. In response to receiving the message 420, the network switch 404 stores (e.g., the communication protocol controller 320 stores) an indication of which member 408 is the root for the scatter operation, in an embodiment.

Also in response to receiving the message 420, the network switch 404 generates (828) and transmits (e.g., the communication protocol controller 320 generates and prompts the network switch 300 to transmit) the message 436, in an embodiment. Because the scatter operation involves the root member distributing respective data to other respective members of the collective, the broadcast operation does not include waiting (428) for input data from all members of the collective, in an embodiment.

As discussed above, the message 436 has the packet format 500, in an embodiment, and the data to be distributed is included in the payload 508. In an embodiment, the network switch 404 generates (e.g., the communication protocol controller 320 generates) the message 436 to include the root indication information 544 set to indicate the message 436 corresponds to a root.

An upstream switch will generate and transmit the message 452 that includes the data to be distributed; and the network switch 404 receives the message 452 from one of the upstream switches 412.

The network switch 404 stores the message 452 in a buffer (e.g., one of the buffers 312) corresponding to the upstream switch 412 that transmitted the message 452, in an embodiment.

In an embodiment, the communication protocol controller 320 uses the collective ID information 532 in the message 452 to determine the members 408 to which the message 452 corresponds. In another embodiment, the switch-to-switch protocol controller 320 additionally or alternatively uses suitable header information 504 other than the collective ID information 532 in the message 452 to determine the members 408 to which the message 452 corresponds. The network switch 404 replicates (460) the message 452 so that instances of the message 452 are available for all members 408 of the collective. For example, the communication protocol controller 320 replicates (460) the message 452.

Because only the non-root members are to receive the data, the network switch 404 filters (762) the instances of the message 452. Filtering (762) the instances of the message 452 includes, for the root member 408, dropping packets corresponding to the data to be distributed except a last packet.

Also, because only the non-root members are to receive different respective portions of the data, the network switch 404 filters (862) the instances of the message 452 so that each instance corresponding to a non-root member only includes the respective data corresponding to the non-root member. Filtering (862) the instances of the message 452 also includes, for each non-root member 408, dropping packets corresponding to data that is to be distributed to other non-root members.

The network switch 404 stores information that indicates how the data in the message 452 is to be distributed amongst the non-root members 408, and the network switch 404 uses such information to filter (862) the instances of the message 452, in an embodiment. In an embodiment, the information that indicates how the data in the message 452 is to be distributed amongst the non-root members 408 is included in the message 452. In another embodiment, the network switch 404 receives, from the network controller 140, the information that indicates how the data in the message 452 is to be distributed amongst the non-root members 408.

In an embodiment, the network device 404 determines (e.g., the communication protocol controller 320 determines) which member 408 is the root and which other members 408 are non-root members using the previously stored indication of which member 408 is the root for the scatter operation.

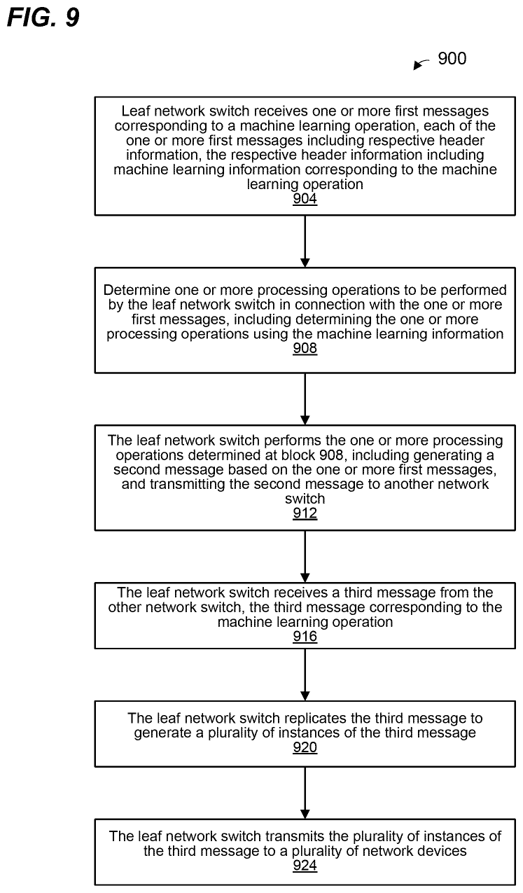

FIG. 9 is a simplified flow diagram of an example method 900 for routing traffic in a machine learning system, according to an embodiment. The method 900 is implemented in the system 100 of FIG. 1, in an embodiment, and the method 900 is described with reference to FIG. 1 for ease of explanation. In other embodiments, the method 900 is implemented in another suitable system different than the system 100 of FIG. 1. The method 900 is implemented by the network switch 300 of FIG. 3, in an embodiment, and the method 900 is described with reference to FIG. 3 for ease of explanation. In other embodiments, the method 900 is implemented by another suitable network switch different than the network switch 300 of FIG. 3.

The method 900 involves processing messages having the format illustrated in FIG. 5, in an embodiment, and the method 900 is described with reference to FIG. 5 for ease of explanation. In other embodiments, the method 900 involves processing messages having a suitable format different than the format illustrated in FIG. 5.

In various embodiments, the method 900 is implemented as part of performing one or more of the machine learning operations discussed above with reference to FIGS. 4 and 6-8. In other embodiments, the method 900 is implemented additionally or alternatively as part of performing one or more machine learning operations different than the machine learning operations discussed above with reference to FIGS. 4 and 6-8.

At block 904, a leaf network switch receives one or more first messages from one or more network devices amongst a plurality of network devices communicatively connected to the leaf network switch, the one or more first messages corresponding to a machine learning operation, each of the one or more first messages including respective header information, the respective header information including machine learning information corresponding to the machine learning operation. In an embodiment, the machine learning information corresponds to the header information 512. In other embodiments, the machine learning information additionally or alternatively includes other suitable machine learning information different than the machine learning information of the header information 512.

At block 908, the leaf network switch determines one or more processing operations to be performed by the leaf network switch in connection with the one or more first messages, including determining the one or more processing operations using the machine learning information. At least when the header information in the one or more first messages includes the collective operation type information 536, determining the one or more processing operations at block 908 includes determining the one or more processing operations using the collective operation type information 536, in an embodiment. In another embodiment in which the header information in the one or more first messages includes the reduce operation type information 540, determining the one or more processing operations at block 908 includes determining the one or more processing operations further using the reduce operation type information 540.

At block 912, the leaf network switch performs the one or more processing operations determined at block 908. In an embodiment, performing the one or more processing operations at block 912 includes generating a second message based on the one or more first messages, and transmitting the second message to another network switch communicatively connected to a second subset of the plurality of network interfaces. In an embodiment, generating the second message at block 912 comprises generating the second message according to an absolute addressing mode.

At block 916, the leaf network switch receives a third message from the other network switch, the third message corresponding to the machine learning operation. In an embodiment, the third message is generated by the other network switch according to the absolute addressing mode.

At block 920, the leaf network switch replicates the third message to generate a plurality of instances of the third message.

At block 924, the leaf network switch transmits the plurality of instances of the third message to respective network devices amongst the plurality of network devices.

In an embodiment, the method 900 further includes filtering, by the leaf network switch, the plurality of instances of the third message prior to transmitting the plurality of instances of the third message at block 924.

Embodiment 1: A leaf network switch for routing traffic in a machine learning system, comprising: a plurality of network interfaces; one or more processors configured to: receive one or more first messages from one or more network devices amongst a plurality of network devices communicatively connected to a first subset of the plurality of network interfaces, the one or more first messages corresponding to a machine learning operation, each of the one or more first messages including respective header information, the respective header information including machine learning information corresponding to the machine learning operation, determine one or more processing operations to be performed by the leaf network switch in connection with the one or more first messages, including determining the one or more processing operations using the machine learning information, perform the one or more processing operations, including generating a second message based on the one or more first messages, and transmitting the second message to another network switch communicatively connected to a second subset of the plurality of network interfaces, receive a third message from the other network switch, the third message corresponding to the machine learning operation, replicate the third message to generate a plurality of instances of the third message, and transmit the plurality of instances of the third message to respective network devices amongst the plurality of network devices via the first subset of the plurality of network interfaces.

Embodiment 2: The leaf network switch of embodiment 1, wherein the one or more processors are further configured to: filter the plurality of instances of the third message prior to transmitting the plurality of instances of the third message.

Embodiment 3: The leaf network switch of embodiment 2, wherein the one or more first messages comprise multiple first messages from respective network devices, wherein each first message includes, amongst respective header information, a respective indicator that indicate whether the respective network device corresponds to a root member corresponding to the machine learning operation, and wherein the one or more processors are configured to: determine, using the indicators in the multiple first messages, one network device that corresponds to the root member; filter the plurality of instances of the third message by at least removing payload data from instances of the third message that are to be transmitted to network devices that correspond to non-root members corresponding to the machine learning operation.

Embodiment 4: The leaf network switch of embodiment 2, wherein the one or more first messages comprise multiple first messages from respective network devices, wherein each first message includes, amongst respective header information, a respective indicator that indicate whether the respective downstream device corresponds to a root member corresponding to the machine learning operation, and wherein the one or more processors are configured to: determine, using the indicators in the multiple first messages, one network device that corresponds to the root member; filter the plurality of instances of the fourth message by at least removing payload data from an instance of the third message that is to be transmitted to the one network device that corresponds to the root member.

Embodiment 5: The leaf network switch of embodiment 2, wherein: the third message includes respective payload data for respective network devices; and the one or more processors are configured to filter the plurality of instances of the third message by at least, for each of at least some of the instances of the third message, removing payload data that is not for a network device corresponding to the instance of the third message.

Embodiment 6: The leaf network switch of embodiment 1, wherein the one or more first messages comprise multiple first messages from respective downstream network devices, and wherein the one or more processors are configured to perform the one or more processing operations by at least: calculating result information using payload data from the multiple first messages according to a function corresponding to the machine learning operation.

Embodiment 7: The leaf network switch of embodiment 6, wherein the one or more processors are configured to: generate the second message to include the result information.

Embodiment 8: The leaf network switch of embodiment 1, wherein: each of the header information of the one or more first messages includes an indication of a type of the machine learning operation; and the one or more processors are configured to determine the one or more processing operations to be performed by the first network switch in connection with the one or more first messages by at least determining the one or more processing operations using the indication of the type of the machine learning operation in the one or more first messages.

Embodiment 9: The leaf network switch of embodiment 1, wherein the one or more processors are configured to generate the second message according to an absolute addressing mode.

Embodiment 10: The leaf network switch of embodiment 9, wherein the third message was generated by the other network switch according to the absolute addressing mode.

Embodiment 11: A method for routing traffic in a machine learning system, the method comprising: receiving, at a leaf network switch, one or more first messages from one or more network devices amongst a plurality of network devices communicatively connected to the leaf network switch, the one or more first messages corresponding to a machine learning operation, each of the one or more first messages including respective header information, the respective header information including machine learning information corresponding to the machine learning operation; determining, at the leaf network switch, one or more processing operations to be performed by the leaf network switch in connection with the one or more first messages, including determining the one or more processing operations using the machine learning information; performing, by the leaf network switch, the one or more processing operations, including generating a second message based on the one or more first messages, and transmitting the second message to another network switch; receiving, at the leaf network switch, a third message from the other network switch, the third message corresponding to the machine learning operation; replicating, at the leaf network switch, the third message to generate a plurality of instances of the third message; and transmitting, by the leaf network switch, the plurality of instances of the third message to respective network devices amongst the plurality of network devices.

Embodiment 12: The method for routing traffic of embodiment 11, further comprising: filtering, at the first network switch, the plurality of instances of the third message prior to transmitting the plurality of instances of the third message.

Embodiment 13: The method for routing traffic of embodiment 12, wherein receiving the one or more first messages comprises receiving multiple first messages from respective network devices, wherein each first message includes, amongst respective header information, a respective indicator that indicate whether the respective network device corresponds to a root member corresponding to the machine learning operation, and wherein the method further comprises: determining, using the indicators in the multiple first messages, one network device that corresponds to the root member; wherein filtering the plurality of instances of the third message comprises removing payload data from instances of the third message that are to be transmitted to network devices that correspond to non-root members corresponding to the machine learning operation.

Embodiment 14: The method for routing traffic of embodiment 12, wherein receiving the one or more first messages comprises receiving multiple first messages from respective network devices, wherein each first message includes, amongst respective header information, a respective indicator that indicate whether the respective downstream device corresponds to a root member corresponding to the machine learning operation, and wherein the method further comprises: determining, using the indicators in the multiple first messages, one network device that corresponds to the root member; wherein filtering the plurality of instances of the fourth message comprises removing payload data from an instance of the third message that is to be transmitted to the one network device that corresponds to the root member.

Embodiment 15: The method for routing traffic of embodiment 12, wherein: the third message includes respective payload data for respective network devices; and filtering the plurality of instances of the third message comprises, for each of at least some of the instances of the third message, removing payload data that is not for a network device corresponding to the instance of the third message.

Embodiment 16: The method for routing traffic of embodiment 11, wherein receiving the one or more first messages comprises receiving multiple first messages from respective downstream network devices, and wherein performing the one or more processing operations comprises: calculating, at the leaf network switch, result information using payload data from the multiple first messages according to a function corresponding to the machine learning operation.

Embodiment 17: The method for routing traffic of embodiment 16, further comprising: generating, at the leaf network switch, the second message to include the result information.

Embodiment 18: The method for routing traffic of embodiment 11, wherein: each of the header information of the one or more first messages includes an indication of a type of the machine learning operation; and determining the one or more processing operations to be performed by the first network switch in connection with the one or more first messages includes determining the one or more processing operations using the indication of the type of the machine learning operation in the one or more first messages.

Embodiment 19: The method for routing traffic of embodiment 11, wherein generating the second message based on the one or more first messages comprises generating the second message according to an absolute addressing mode.

Embodiment 20: The method for routing traffic of embodiment 19, wherein the third message was generated by the other network switch according to the absolute addressing mode.

Some of the various blocks, operations, and techniques described above may be implemented utilizing hardware, a processor executing firmware instructions, a processor executing software instructions, or any suitable combination thereof. When implemented utilizing a processor executing software or firmware instructions, the software or firmware instructions may be stored in any suitable computer readable memory. The software or firmware instructions may include machine readable instructions that, when executed by one or more processors, cause the one or more processors to perform various acts such as described above.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A leaf network switch for routing traffic in a machine learning system, comprising:
a plurality of network interfaces;
one or more processors configured to:
receive one or more first messages from one or more network devices amongst a plurality of network devices communicatively connected to a first subset of the plurality of network interfaces, the one or more first messages corresponding to a machine learning operation, each of the one or more first messages including respective header information, the respective header information including machine learning information corresponding to the machine learning operation,
determine one or more processing operations to be performed by the leaf network switch in connection with the one or more first messages, including determining the one or more processing operations using the machine learning information,
perform the one or more processing operations, including generating a second message based on the one or more first messages, and transmitting the second message to another network switch communicatively connected to a second subset of the plurality of network interfaces,
receive a third message from the other network switch, the third message corresponding to the machine learning operation,
replicate the third message to generate a plurality of instances of the third message, and
transmit the plurality of instances of the third message to respective network devices amongst the plurality of network devices via the first subset of the plurality of network interfaces.

2. The leaf network switch of claim 1, wherein the one or more processors are further configured to:
filter the plurality of instances of the third message prior to transmitting the plurality of instances of the third message.

3. The leaf network switch of claim 2, wherein the one or more first messages comprise multiple first messages from respective network devices, wherein each first message includes, amongst respective header information, a respective indicator that indicate whether the respective network device corresponds to a root member corresponding to the machine learning operation, and wherein the one or more processors are configured to:
determine, using the indicators in the multiple first messages, one network device that corresponds to the root member;
filter the plurality of instances of the third message by at least removing payload data from instances of the third message that are to be transmitted to network devices that correspond to non-root members corresponding to the machine learning operation.

4. The leaf network switch of claim 2, wherein the one or more first messages comprise multiple first messages from respective network devices, wherein each first message includes, amongst respective header information, a respective indicator that indicate whether the respective downstream device corresponds to a root member corresponding to the machine learning operation, and wherein the one or more processors are configured to:
determine, using the indicators in the multiple first messages, one network device that corresponds to the root member;
filter the plurality of instances of the fourth message by at least removing payload data from an instance of the third message that is to be transmitted to the one network device that corresponds to the root member.

5. The leaf network switch of claim 2, wherein:
the third message includes respective payload data for respective network devices; and
the one or more processors are configured to filter the plurality of instances of the third message by at least, for each of at least some of the instances of the third message, removing payload data that is not for a network device corresponding to the instance of the third message.

6. The leaf network switch of claim 1, wherein the one or more first messages comprise multiple first messages from respective downstream network devices, and wherein the one or more processors are configured to perform the one or more processing operations by at least:
calculating result information using payload data from the multiple first messages according to a function corresponding to the machine learning operation.

7. The leaf network switch of claim 6, wherein the one or more processors are configured to:
generate the second message to include the result information.

8. The leaf network switch of claim 1, wherein:
each of the header information of the one or more first messages includes an indication of a type of the machine learning operation; and
the one or more processors are configured to determine the one or more processing operations to be performed by the first network switch in connection with the one or more first messages by at least determining the one or more processing operations using the indication of the type of the machine learning operation in the one or more first messages.

9. The leaf network switch of claim 1, wherein the one or more processors are configured to generate the second message according to an absolute addressing mode.

10. The leaf network switch of claim 9, wherein the third message was generated by the other network switch according to the absolute addressing mode.

11. A method for routing traffic in a machine learning system, the method comprising:
receiving, at a leaf network switch, one or more first messages from one or more network devices amongst a plurality of network devices communicatively connected to the leaf network switch, the one or more first messages corresponding to a machine learning operation, each of the one or more first messages including respective header information, the respective header information including machine learning information corresponding to the machine learning operation;
determining, at the leaf network switch, one or more processing operations to be performed by the leaf network switch in connection with the one or more first messages, including determining the one or more processing operations using the machine learning information;
performing, by the leaf network switch, the one or more processing operations, including generating a second message based on the one or more first messages, and transmitting the second message to another network switch;
receiving, at the leaf network switch, a third message from the other network switch, the third message corresponding to the machine learning operation;
replicating, at the leaf network switch, the third message to generate a plurality of instances of the third message; and
transmitting, by the leaf network switch, the plurality of instances of the third message to respective network devices amongst the plurality of network devices.

12. The method for routing traffic of claim 11, further comprising:
filtering, at the first network switch, the plurality of instances of the third message prior to transmitting the plurality of instances of the third message.

13. The method for routing traffic of claim 12, wherein receiving the one or more first messages comprises receiving multiple first messages from respective network devices, wherein each first message includes, amongst respective header information, a respective indicator that indicate whether the respective network device corresponds to a root member corresponding to the machine learning operation, and wherein the method further comprises:
determining, using the indicators in the multiple first messages, one network device that corresponds to the root member;
wherein filtering the plurality of instances of the third message comprises removing payload data from instances of the third message that are to be transmitted to network devices that correspond to non-root members corresponding to the machine learning operation.

14. The method for routing traffic of claim 12, wherein receiving the one or more first messages comprises receiving multiple first messages from respective network devices, wherein each first message includes, amongst respective header information, a respective indicator that indicate whether the respective downstream device corresponds to a root member corresponding to the machine learning operation, and wherein the method further comprises:
determining, using the indicators in the multiple first messages, one network device that corresponds to the root member;
wherein filtering the plurality of instances of the fourth message comprises removing payload data from an instance of the third message that is to be transmitted to the one network device that corresponds to the root member.

15. The method for routing traffic of claim 12, wherein:
the third message includes respective payload data for respective network devices; and
filtering the plurality of instances of the third message comprises, for each of at least some of the instances of the third message, removing payload data that is not for a network device corresponding to the instance of the third message.

16. The method for routing traffic of claim 11, wherein receiving the one or more first messages comprises receiving multiple first messages from respective downstream network devices, and wherein performing the one or more processing operations comprises:
calculating, at the leaf network switch, result information using payload data from the multiple first messages according to a function corresponding to the machine learning operation.

17. The method for routing traffic of claim 16, further comprising:
generating, at the leaf network switch, the second message to include the result information.

18. The method for routing traffic of claim 11, wherein:
each of the header information of the one or more first messages includes an indication of a type of the machine learning operation; and
determining the one or more processing operations to be performed by the first network switch in connection with the one or more first messages includes determining the one or more processing operations using the indication of the type of the machine learning operation in the one or more first messages.

19. The method for routing traffic of claim 11, wherein generating the second message based on the one or more first messages comprises generating the second message according to an absolute addressing mode.

20. The method for routing traffic of claim 19, wherein the third message was generated by the other network switch according to the absolute addressing mode.
